(19) United States
(12) Patent Application Publication
(10) Pub. No.: US 2026/0253560 A1
(43) Pub. Date: Aug. 27, 2026

(54) IMAGE DISPLAY DEVICE, IMAGE DISPLAY SYSTEM, IMAGE DISPLAY METHOD, AND STORAGE MEDIUM

(71) Applicant: Panasonic Automotive Systems Co., Ltd., Kanagawa (JP)

(72) Inventor: Satoshi MIKAYAMA, Kanagawa (JP)

(73) Assignee: Panasonic Automotive Systems Co., Ltd., Kanagawa (JP)

(21) Appl. No.: 19/448,724

(22) Filed: Jan. 14, 2026

(30) Foreign Application Priority Data
Feb. 21, 2025 (JP) 2025-026807

(51) Int. Cl. G09G 3/34

(52) U.S. Cl. CPC G09G 3/3406; G09G 2320/0646

(57) ABSTRACT

An image display device that performs local dimming control includes: an image display that displays an image; a light that lights up as a backlight for the image display; a communicator that communicates with an external device (drawing processing device) to acquire the image and lighting information for controlling the light based on the image; and a lighting processor that controls the light based on a time difference between a lighting timing indicated by the lighting information and a display timing of the image, the image is one of a plurality of images that are displayed by the image display, and the lighting processor generates complementary lighting information: that is based on an (N−1)th image and an Nth image among the plurality of images; and that complements a period between a display timing of the (N−1)th image and a display timing of the Nth image.

### CROSS REFERENCE TO RELATED APPLICATION

The present application is based on and claims priority of Japanese Patent Application No. 2025-026807 filed on Feb. 21, 2025.

### FIELD

The present disclosure relates to an image display device, an image display system, an image display method, and a storage medium.

### BACKGROUND

Patent Literature (PTL) 1 discloses a circuit device which receives image data IMA, and performs local dimming control of a display device based on the image data IMA.

### CITATION LIST

### Patent Literature

PTL 1: Japanese Unexamined Patent Application Publication No. 2024-140059

### SUMMARY

However, the circuit device according to PTL 1 can be improved upon.

In view of this, the present disclosure improves upon the above related art.

An image display device according to an aspect of the present disclosure is an image display device that performs local dimming control, includes: an image display that displays an image; a light that lights up as a backlight for the image display; a communicator that communicates with an external device to acquire the image and lighting information for controlling the light based on the image; and a lighting processor that controls the light based on a time difference between a lighting timing indicated by the lighting information and a display timing of the image, the image is one of a plurality of images that are displayed by the image display, and the lighting processor generates complementary lighting information: that is based on an (N−1)th image and an Nth image among the plurality of images; and that complements a period between a display timing of the (N−1)th image and a display timing of the Nth image.

An image display device and the like according to the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram of an image display device according to an embodiment.

FIG. 2 is an illustrative view showing a display delay between images and lighting information in local dimming control.

FIG. 3 is a sequence diagram showing an operation performed by the image display device when complementary lighting information is generated.

FIG. 4 is an illustrative view showing a case where the complementary lighting information is generated.

FIG. 5 is an illustrative view showing a case where the complementary lighting information corresponding to an (N+1)th image is generated from an (N−1)th image and an Nth image.

FIG. 6 is an illustrative view showing amounts of change in brightness ΔL (i, j) between brightnesses in a lighting area D (t−1) and brightnesses in a lighting area D (t).

FIG. 7 is a diagram showing a table for clustering.

FIG. 8 is an illustrative view showing the direction of change in brightness.

FIG. 9 is a diagram showing the directions of change in brightness in the amounts of change in brightness ΔL (i, j).

FIG. 10 is an illustrative view showing a brightness increase determination.

### DESCRIPTION OF EMBODIMENT

An embodiment will be specifically described below with reference to drawings.

The embodiment described below indicates a general or specific example. Numerical values, shapes, materials, constituent elements, the arrangement and connection of the constituent elements, and the like shown in the following embodiment are examples, and are not intended to limit the present disclosure. Among the constituent elements in the following embodiment, constituent elements which are not recited in the independent claims are described as optional constituent elements.

The drawings are schematic views, and are not exactly shown. In the drawings, the same constituent members are identified with the same reference signs.

In the following embodiment, expressions such as “in the form of a two-dimensional matrix” are used. For example, “in the form of a two-dimensional matrix” means not only “completely in a two-dimensional matrix” but also “substantially in a two-dimensional matrix”. In other words, “in the form of a two-dimensional matrix” also mean that about a several percent error is included. In a range where effects in the present disclosure can be achieved, “in the form of a two-dimensional matrix” is provided. The same is true for other expressions using “in the form of”.

### EMBODIMENT

### <Configurations and Functions>

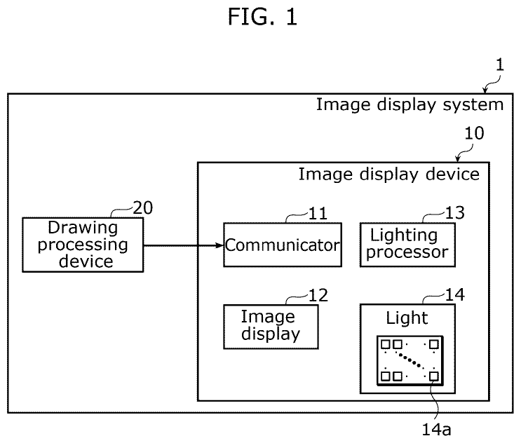

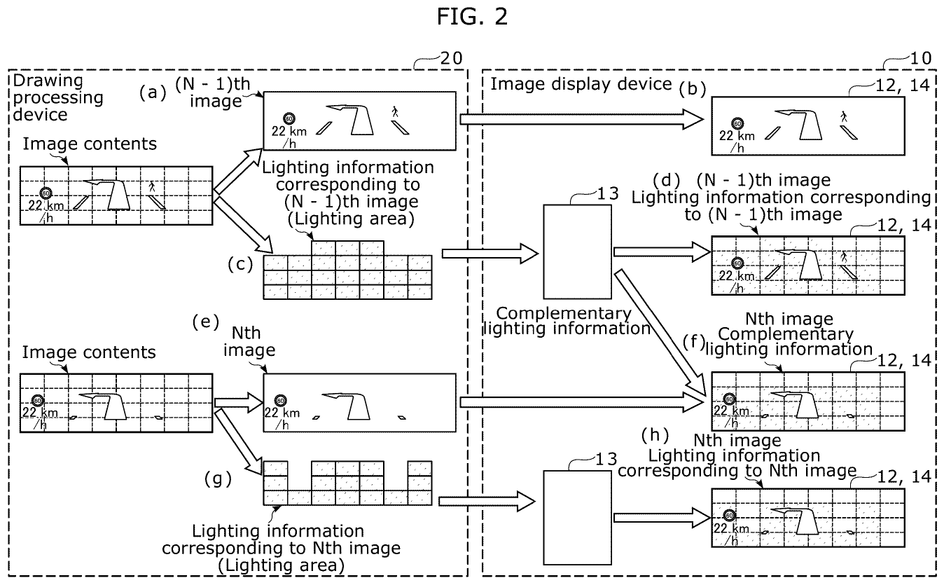

Image display device 10, image display system 1, an image display method, and a program will first be described with reference to FIGS. 1 and 2.

FIG. 1 is a block diagram of image display device 10 according to the embodiment. FIG. 2 is an illustrative view showing a display delay between images and lighting information in local dimming control. Part (a) in FIG. 2 shows an (N−1)th image obtained by subjecting image contents to drawing processing. Part (b) in FIG. 2 shows the (N−1)th image displayed by image display 12. Part (c) in FIG. 2 shows lighting information corresponding to the (N−1)th image which indicates a lighting area corresponding to the (N−1)th image subjected to the drawing processing. Part (d) in FIG. 2 shows the (N−1)th image displayed by image display 12 and the lighting area emitted by light 14 based on the lighting information corresponding to the (N−1)th image. Part (e) in FIG. 2 shows an Nth image obtained by subjecting the image contents to the drawing processing. Part (f) in FIG. 2 shows the Nth image displayed by image display 12 and a lighting area emitted by light 14 based on complementary lighting information. Part (g) in FIG. 2 shows lighting information corresponding to the Nth image which indicates a lighting area corresponding to the Nth image subjected to the drawing processing. Part (h) in FIG. 2 shows the Nth image displayed by image display 12 and the lighting area emitted by light 14 based on the lighting information corresponding to the Nth image. In parts (c), (d), (f), (g), and (h) in FIG. 2, the lighting areas are hatched with dots.

Image display system 1 is, for example, a system which is installed in a mover such as a vehicle. In image display system 1 in the present embodiment, a backlight capable of performing the local dimming control is used, and thus it is possible to display an image which can be recognized by a user.

Specifically, image display system 1 includes drawing processing device 20 and image display device 10.

Drawing processing device 20 can perform the drawing processing for displaying an image on image display device 10. Specifically, drawing processing device 20 performs control to output an image obtained by subjecting the image contents to the drawing processing to image display device 10 and to thereby display the image which can be recognized by the user on image display device 10. The image contents are information for controlling image display 12 in image display device 10. The image contents include, for example, a personal related image, an amusement image, navigation information, a vehicle instrument, the operation status of an in-vehicle device, and information such as surrounding vehicle information. The image contents are acquired, for example, from a storage installed in image display system 1 or an external server.

Drawing processing device 20 includes, for example, a GPU, a VRAM, a rendering engine, a firmware buffer, and the like. Drawing processing device 20 is, for example, a CDC. Drawing processing device 20 is an example of an external device.

Drawing processing device 20 generates, based on an image subjected to the drawing processing, the lighting information for controlling light 14 in image display device 10.

Specifically, drawing processing device 20 performs normalization such that a plurality of lighting regions arranged in the form of a two-dimensional matrix coincide with a plurality of image regions indicated by the image subjected to the drawing processing. In this way, the lighting regions correspond to the image regions. Drawing processing device 20 determines brightnesses in the lighting regions based on the image regions of the image subjected to the drawing processing. In other words, based on the drawn image, drawing processing device 20 identifies one or more light-emitting elements 14a to be lit, and sets a current to be supplied to the one or more light-emitting elements 14a which have been identified. In this way, the lighting area in the lighting regions arranged in the form of a two-dimensional matrix is determined. Here, drawing processing device 20 also determines a lighting period corresponding to the lighting area. In this way, drawing processing device 20 generates the lighting information.

The lighting information is lighting control information with which lighting processor 13 performs the local dimming control to control light 14. Although the image subjected to the drawing processing is divided into a plurality of image regions arranged in the form of a two-dimensional matrix, in order to individually and independently control a plurality of lighting regions arranged in the form of a two-dimensional matrix in the local dimming control, the lighting information includes information such as brightnesses, lighting periods, and the like in the lighting regions. The lighting regions correspond to the image regions. The brightnesses include a brightness greater than 0 which means lighting and a brightness of 0 which means extinguishment. The image region is a region which is formed with one or more pixels among a plurality of pixels in the drawn image.

In the present embodiment, drawing processing device 20 may generate the lighting information for one frame among images in a plurality of frames.

Examples of image display device 10 include an in-vehicle display device, a television device installed in a facility or the like, and an information processing device including a display. Examples of the in-vehicle display device include a meter panel, a center information display, a head-up display, and an electronic mirror.

Specifically, image display device 10 includes communicator 11, image display 12, lighting processor 13, and light 14.

Communicator 11 is a communication interface which can communicate with drawing processing device 20 via a network. Communicator 11 receives, via the network, an image generated as a result of the image contents being subjected by drawing processing device 20 to the drawing processing, the lighting information generated based on the image, and the like. The network is, for example, a local area network, an in-vehicle network, or the like. Communicator 11 outputs the acquired image to image display 12, and outputs the acquired lighting information to lighting processor 13.

Image display 12 is a display which can display the image generated as a result of the image contents being subjected by drawing processing device 20 to the drawing processing such that the user can recognize the image. Examples of image display 12 include a liquid crystal display, an organic EL display, and the like.

Lighting processor 13 can perform lighting processing for causing light 14 to light up based on the lighting information generated by drawing processing device 20. Specifically, lighting processor 13 generates, based on the lighting information, control signals for individually controlling a plurality of lighting regions in light 14. Lighting processor 13 controls light 14 based on the generated control signals. The control signals include brightnesses, lighting periods, and the like in the lighting regions of light 14.

Since as described above, drawing processing device 20 generates the lighting information after generating the image subjected to the drawing processing, the lighting information may be transmitted to lighting processor 13 with a delay of several tens of milliseconds to about 100 milliseconds after the image subjected to the drawing processing. When as described above, drawing processing device 20 generates the lighting information for one frame among images in a plurality of frames, even if the image is updated, the lighting information is not updated, with the result that a delay occurs. Hence, in the present embodiment, lighting processor 13 controls light 14 based on a time difference between a lighting timing indicated by the lighting information and the display timing of the image.

Specifically, lighting processor 13 compares the (N−1)th image subjected to the drawing processing and the Nth image subjected to the drawing processing. Lighting processor 13 may compare the lighting information (hereinafter also referred to as the lighting information corresponding to the (N−1)th image) indicating the lighting area corresponding to the (N−1)th image and the lighting information (hereinafter also referred to as the lighting information corresponding to the Nth image) indicating the lighting area corresponding to the Nth image. Lighting processor 13 generates the complementary lighting information for complementing a period between the display timing of the (N−1)th image and the display timing of the Nth image. In other words, lighting processor 13 generates the complementary lighting information to complement a period between the lighting timing of light 14 based on the lighting information corresponding to the (N−1)th image and the lighting timing of light 14 based on the lighting information corresponding to the Nth image. The complementary lighting information is lighting information which can complement a change from the lighting information indicating the lighting area corresponding to the (N−1)th image to the lighting information indicating the lighting area corresponding to the Nth image. N is a natural number greater than or equal to 2.

Lighting processor 13 controls light 14 based on the complementary lighting information. Light 14 is caused to light up based on the complementary lighting information, and thus it is possible to smoothly change the brightness of image display 12 when light 14 lights up based on the lighting information corresponding to the (N−1)th image to the brightness of image display 12 when light 14 lights up based on the lighting information corresponding to the Nth image. Hence, the user is unlikely to feel uncomfortable due to changes in light in image display 12.

Light 14 is a backlight which is disposed opposite the back surface on a side opposite to the front surface of image display 12. Light 14 is controlled by lighting processor 13 to be able to emit light based on the lighting information. Light 14 includes a plurality of light-emitting elements 14a arranged in the form of a two-dimensional matrix. Light-emitting element 14a is, for example, a light-emitting diode (LED) module. A plurality of light-emitting elements 14a correspond one-to-one to a plurality of lighting regions. A plurality of image regions may correspond one-to-one to a plurality of light-emitting elements 14a.

For example, light 14 is controlled by lighting processor 13, and thus a plurality of light-emitting elements 14a are individually driven based on the control signals. In other words, lighting processor 13 controls light 14 based on the control signals, and thus a current is supplied to light-emitting elements 14a which are indicated by the control signals and serve as targets among the plurality of light-emitting elements 14a, with the result that light-emitting elements 14a are lit at a predetermined brightness whereas no current is supplied to light-emitting elements 14a which are indicated by the control signals and serve as non-targets among the plurality of light-emitting elements 14a, with the result that light-emitting elements 14a are not lit.

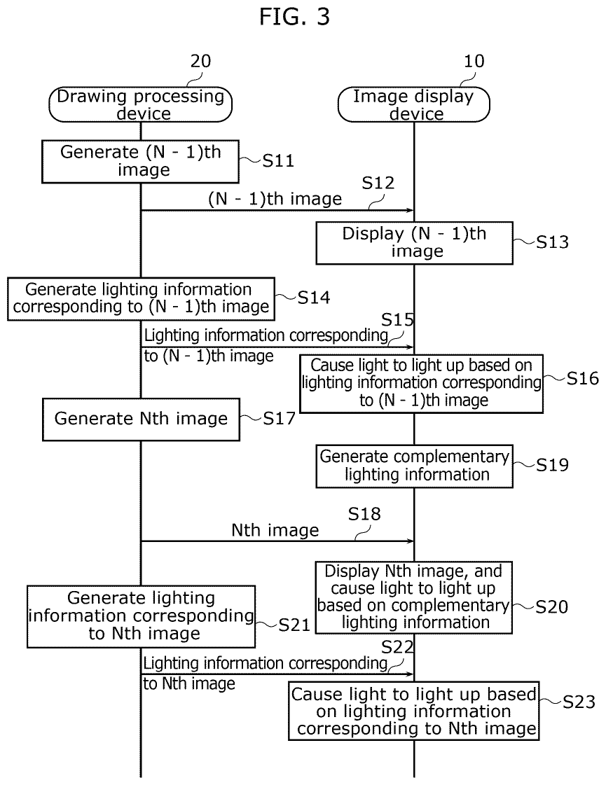

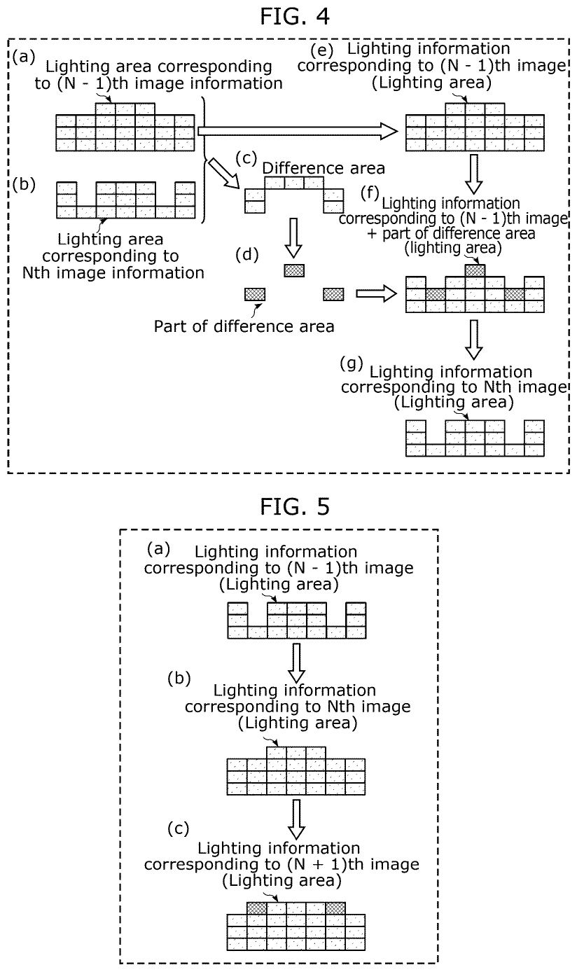

Here, a case where the complementary lighting information is generated which complements a period between the display timing at which the (N−1)th image is displayed and the display timing at which the Nth image is displayed will be described with reference to FIGS. 3 and 4.

FIG. 3 is a sequence diagram showing an operation performed by image display device 10 when the complementary lighting information is generated. FIG. 4 is an illustrative view showing the case where the complementary lighting information is generated. Part (a) in FIG. 4 shows the lighting information corresponding to the (N−1)th image. Part (b) in FIG. 4 shows the lighting information corresponding to the Nth image. Part (c) in FIG. 4 shows a difference area. Part (d) in FIG. 4 shows a part of the difference area. Part (e) in FIG. 4 shows the lighting information corresponding to the (N−1)th image. Part (f) in FIG. 4 shows a lighting area (complement) obtained by adding the part of the difference area to the lighting information corresponding to the Nth image after part (e) in FIG. 4. Part (g) in FIG. 4 shows the lighting information corresponding to the Nth image after part (f) in FIG. 4.

As shown in part (a) in FIG. 2, drawing processing device 20 first subjects the image contents to the drawing processing to generate the (N−1)th image (S11). Drawing processing device 20 outputs the (N−1)th image subjected to the drawing processing to image display device 10 (S12).

Then, as shown in part (b) in FIG. 2, communicator 11 of image display device 10 acquires the (N−1)th image subjected to the drawing processing. In this way, image display 12 displays (outputs) the (N−1)th image (S13).

Then, when drawing processing device 20 generates the (N−1)th image, as shown in part (c) in FIG. 2, drawing processing device 20 generates, based on the (N−1)th image, the lighting information for controlling light 14 in image display device 10 (S14). Specifically, drawing processing device 20 generates, based on the (N−1)th image, the lighting information corresponding to the (N−1)th image with which lighting processor 13 controls light 14 and which corresponds to the (N−1)th image. Drawing processing device 20 outputs the lighting information corresponding to the (N−1)th image generated to image display device 10 (S15).

Then, communicator 11 of image display device 10 acquires the lighting information corresponding to the (N−1)th image subjected to the drawing processing. In this way, lighting processor 13 controls, based on the lighting information corresponding to the (N−1)th image generated by drawing processing device 20, light 14 to cause light 14 to light up (S16). Specifically, as shown in part (d) in FIG. 2, when the (N−1)th image is displayed (output) on image display 12, lighting processor 13 causes light-emitting elements 14a which correspond to the lighting area indicated by the lighting information corresponding to the (N−1)th image and serve as targets to emit light. In this way, image display device 10 visualizes the (N−1)th image for the user.

Then, as shown in part (e) in FIG. 2, drawing processing device 20 subjects the image contents to the drawing processing to generate the Nth image (S17).

When the processing is performed in step S17, lighting processor 13 acquires the (N−1)th image and the Nth image to generate the complementary lighting information based on the (N−1)th image and the Nth image (S19).

Specifically, for example, lighting processor 13 acquires (N−1)th image information and Nth image information from drawing processing device 20. Lighting processor 13 calculates a difference area based on the (N−1)th image information and the Nth image information. Specifically, as shown in parts (a) to (c) in FIG. 4, lighting processor 13 compares the (N−1)th image information and the Nth image information to calculate a difference area between a lighting area corresponding to the (N−1)th image information and a lighting area corresponding to the Nth image information. As shown in parts (d) to (f) in FIG. 4, lighting processor 13 adds a part of the difference area calculated to a lighting area indicated by the lighting information corresponding to the (N−1)th image in accordance with a lighting interval between lighting corresponding to the lighting information corresponding to the (N−1)th image and lighting corresponding to the lighting information corresponding to the Nth image, and thereby generates the complementary lighting information. In the present embodiment, the part of the difference area is a division area obtained by dividing the difference area in half. In other words, the lighting area indicated by the complementary lighting information indicates a lighting area obtained by adding the calculated division area to the lighting area indicated by the lighting information corresponding to the (N−1)th image. As described above, the difference area for generating the complementary lighting information which is used by lighting processor 13 in order to complement a period between a lighting timing at which light 14 lights up based on the lighting information corresponding to the (N−1)th image and a lighting timing at which light 14 lights up based on the lighting information indicated by the lighting area corresponding to the Nth image is an example of difference data.

Then, drawing processing device 20 outputs the Nth image generated in step S17 to image display device 10 (S18). As shown in part (f) in FIG. 2, communicator 11 of image display device 10 acquires the Nth image subjected to the drawing processing. In this way, image display 12 displays the Nth image. Here, as in step S19, lighting processor 13 controls light 14 based on the complementary lighting information at a timing at which the Nth image is displayed on image display 12, and thereby causes light-emitting elements 14a which correspond to the lighting area indicated by the complementary lighting information and serve as targets to emit light (S20). In this way, image display 12 displays the Nth image lit based on the complementary lighting information, and thereby can visualize the Nth image for the user.

Then, when the Nth image is displayed on image display 12 based on the complementary lighting information, as shown in part (g) in FIG. 4, drawing processing device 20 generates, based on the Nth image, the lighting information corresponding to the Nth image with which lighting processor 13 controls light 14 and which corresponds to the Nth image (S21). Drawing processing device 20 outputs the lighting information corresponding to the Nth image generated to image display device 10 (S22).

Then, communicator 11 of image display device 10 acquires the lighting information corresponding to the Nth image subjected to the drawing processing. In this way, as shown in part (g) in FIG. 2, lighting processor 13 controls, based on the lighting information corresponding to the Nth image generated by drawing processing device 20, light 14 to cause light 14 to light up (S23). Specifically, when the Nth image is displayed on image display 12, lighting processor 13 switches from the complementary lighting information to the lighting information corresponding to the Nth image, and controls light 14 based on the lighting information corresponding to the Nth image to cause light-emitting elements 14a which correspond to the lighting area indicated by the lighting information corresponding to the Nth image and serve as targets to emit light. In this way, as shown in part (h) in FIG. 2, image display device 10 can visualize the Nth image lit based on the lighting information corresponding to the Nth image for the user.

Although the case where lighting processor 13 generates the complementary lighting information for complementing the period between the display timing at which the (N−1)th image is displayed and the display timing at which the Nth image is displayed has been described, the present disclosure is not limited to this case. Lighting processor 13 can also generate the complementary lighting information corresponding to the (N+1)th image from the (N−1)th image and the Nth image.

Here, the case where the complementary lighting information corresponding to the (N+1)th image is generated will be described with reference to FIGS. 5 to 10.

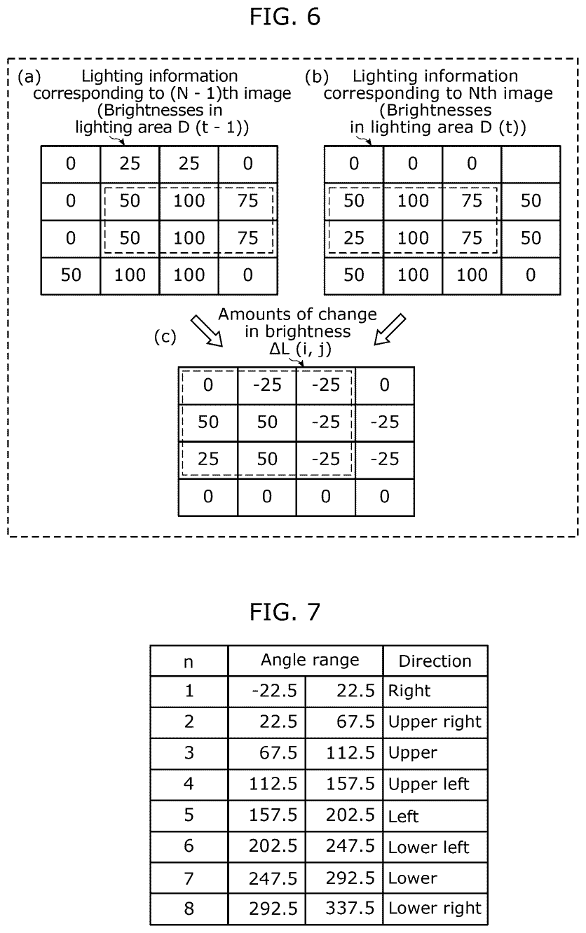

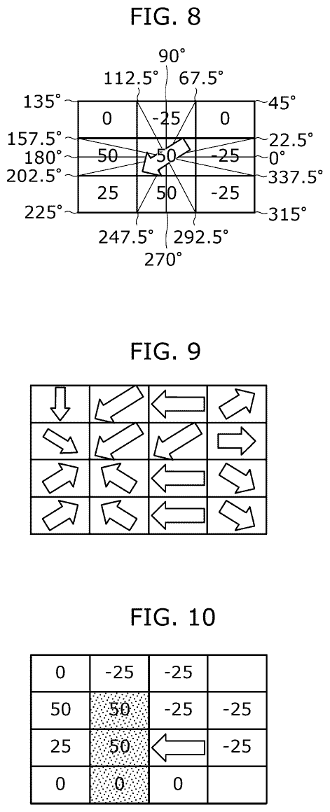

FIG. 5 is an illustrative view showing the case where the complementary lighting information corresponding to the (N+1)th image is generated from the (N−1)th image and the Nth image. Part (a) in FIG. 5 shows the lighting information corresponding to the (N−1)th image. Part (b) in FIG. 5 shows the lighting information corresponding to the Nth image. Part (c) in FIG. 5 shows the lighting information corresponding to the (N+1)th image. FIG. 6 is an illustrative view showing amounts of change in brightness ΔL (i, j) between brightnesses in a lighting area D (t−1) and brightnesses in a lighting area D (t). Part (a) in FIG. 6 shows the brightnesses in the lighting area D (t−1). Part (b) in FIG. 6 shows the brightnesses in the lighting area D (t). Part (c) in FIG. 6 shows the amounts of change in brightness ΔL (i, j). FIG. 7 is a diagram showing a table for clustering. FIG. 8 is an illustrative view showing the direction of change in brightness. FIG. 9 is a diagram showing the directions of change in brightness in the amounts of change in brightness ΔL (i, j). FIG. 10 is an illustrative view showing a brightness increase determination. In each of the (N−1)th image and the Nth image, the area of a 4×4 grid is illustrated.

Lighting processor 13 calculates difference data on a difference between the (N−1)th image and the Nth image, calculates the amount of change in brightness of a specific region included in a lighting area indicated by the difference data calculated and the amount of change in brightness of a related region associated with the specific region, and generates complementary lighting information by estimating the direction of change in brightness based on the amount of change in brightness of the specific region and the amount of change in brightness of the related region.

Specifically, lighting processor 13 calculates the amount of change in brightness based on the lighting information corresponding to the (N−1)th image corresponding to the (N−1)th image and the lighting information corresponding to the Nth image corresponding to the Nth image. Specifically, as shown in parts (a) and (b) in FIG. 6, lighting processor 13 calculates the amounts of change in brightness ΔL (i, j) indicating difference areas between the brightnesses in the lighting area D (t−1) indicated by the lighting information corresponding to the (N−1)th image and the brightnesses in the lighting area D (t) indicated by the lighting information corresponding to the Nth image. The amounts of change in brightness ΔL (i, j) are indicated by the difference areas in part (c) in FIG. 6. Here, (i, j) indicate positions.

Here, lighting processor 13 extracts a region (region indicated by dotted lines) in which contents are moved by change from the brightnesses in the lighting area D (t−1) to the brightnesses in the lighting area D (t) to extract the specific region indicated by the dotted lines from the difference areas of the amounts of change in brightness ΔL (i, j). Part (c) in FIG. 6 illustrates a case where the specific region of a 3×3 grid is extracted. Although the specific region is illustrated with the 3×3 grid, this configuration is merely an example, and the specific region is not limited to the 3×3 grid. The specific region may be an N×M grid. Each of N and M is a natural number greater than or equal to 1.

In lighting processor 13, an equation for calculating brightness change information of regions of the specific region is previously prepared. The regions are indicated by the amounts of change in brightness ΔL (i, j).

In order to predict the complementary lighting information corresponding to the (N+1)th image from the (N−1)th image and the Nth image, lighting processor 13 calculates the direction of change in brightness indicated by the amount of change in brightness (see Math. 1) of regions other than a center part region of the specific region by calculating Equation (3) using Equation (1) and Equation (2) below.

$$[ Math . 1 ]$$

$$Δ \vec{{LB}_{i , j}}$$

$$[ Math . 2 ]$$

$$Δ \vec{{LB}_{i , j}} = ( \sum \{ ( Δ {L}_{i , j} [ n ] - Δ {L}_{i , j} ) \times cos \frac{( n - 1 ) π}{4} \} , \sum \{ ( Δ {L}_{i , j} [ n ] - Δ {L}_{i , j} ) \times sin \frac{( n - 1 ) π}{4} \} ) \qquad Equation ( 1 )$$

$$[ Math . 3 ]$$

$$∠Δ \vec{{LB}_{i , j}} = arc tan ( \sum \{ ( Δ {L}_{i , j} [ n ] - Δ {L}_{i , j} ) \times sin \frac{( n - 1 ) π}{4} \} / \sum \{ ( Δ {L}_{i , j} [ n ] - Δ {L}_{i , j} ) \times cos \frac{( n - 1 ) π}{4} \} ) \qquad Equation ( 2 )$$

$$[ Math . 4 ]$$

$$Equation ( 3 )$$

$$( \begin{matrix}Δ {L}_{i - 1 , j + 1} & Δ {L}_{i , j + 1} & Δ {L}_{i + 1 , j + 1} \\ Δ {L}_{i - 1 , j} & Δ {L}_{i , j} & Δ {L}_{i + 1 , j} \\ Δ {L}_{i - 1 , j - 1} & Δ {L}_{i , j - 1} & Δ {L}_{i + 1 , j - 1}\end{matrix} ) = ( \begin{matrix}Δ {L}_{i , j} [ 4 ] & Δ {L}_{i , j} [ 3 ] & Δ {L}_{i , j} [ 2 ] \\ Δ {L}_{i , j} [ 5 ] & Δ {L}_{i , j} & Δ {L}_{i , j} [ 1 ] \\ Δ {L}_{i , j} [ 6 ] & Δ {L}_{i , j} [ 7 ] & Δ {L}_{i , j} [ 8 ]\end{matrix} )$$

ΔL_{i,j} [n] represents the regions other than the center part region of the specific region of the 3×3 grid shown in part (c) in FIG. 6.

[n] is a number assigned to the regions other than the center part region. In the present embodiment, there are eight regions, and thus n is any one of 1 to 8.

ΔL_{i,j} represents the center part region of the specific region of the 3×3 grid shown in part (c) in FIG. 6.

A part (see Math. 5) of Equation (2) represents an angle.

$$\begin{matrix}[ Math . 5 ] & \\ ∠Δ \vec{{LB}_{i , j}} & \end{matrix}$$

Using Equation (2), as shown in Equation (3), the amount of change in brightness of the regions other than the center part region of the specific region, that is, an angle capable of estimating the direction of change in brightness is determined.

In Equation (3), the specific region of the 3×3 grid shown in part (c) in FIG. 6 can be represented.

ΔL_{i,j} in Equation (3) represents the center part region of the specific region shown in part (c) in FIG. 6.

Equation (3) can be represented as shown in FIGS. 7 and 8. In Equation (3), ΔL_{i,j} [1] represents a range (mainly in the direction of 0°) from −22.5° to 22.5° about the center part region, ΔL_{i,j} [2] represents a range (mainly in the direction of 45°) from 22.5° to 67.5° about the center part region, ΔL_{i, j} [3] represents a range (mainly in the direction of 90°) from 67.5° to 112.5° about the center part region, ΔL_{i,j} [4] represents a range (mainly in the direction of 135°) from 112.5° to 157.5° about the center part region, ΔL_{i,j} [5] represents a range (mainly in the direction of 180°) from 157.5° to 202.5° about the center part region, ΔL_{i,j} [6] represents a range (mainly in the direction of 225°) from 202.5° to 247.5° about the center part region, ΔL_{i,j} [7] represents a range (mainly in the direction of 270°) from 247.5° to 292.5° about the center part region, and ΔL_{i, j} [8] represents a range (mainly in the direction of 315°) from 292.5° to 337.5° about the center part region.

Regarding the angle in Equation (2) calculated by Equation (1), lighting processor 13 determines the amounts of change in brightness ΔL_{i,j} [n] of the regions other than the center part region of the specific region, and performs clustering. In this way, as shown in FIG. 9, lighting processor 13 can calculate the directions of change in brightness in the specific region.

Lighting processor 13 calculates the directions of change in brightness, and then votes for a brightness increase request for each area.

For example, in a left-pointing arrow shown in FIG. 10, lighting processor 13 votes for an addition to add a predetermined value to three areas (related regions associated with the center part region of the specific region) which are an area adjacent to the left of the area where the arrow exists, an upper left adjacent area, and a lower left adjacent area. A score V_{i,j} is set for each area, and if the score V_{i,j} is greater than or equal to a certain threshold value as a result of voting, lighting processor 13 performs the brightness increase determination on the three squares.

Lighting processor 13 adds the areas subjected to the brightness increase determination (areas having amounts of change in brightness of the related region) to the lighting area indicated by the lighting information corresponding to the Nth image, and thereby generates the complementary lighting information indicating a lighting area after the addition.

### OPERATIONAL EFFECTS

The operational effects of image display device 10, image display system 1, the image display method, and the program in the present embodiment will be described below.

However, when in the circuit device disclosed in PTL, lighting information for a local dimming area is calculated by a central electronic control unit (ECU) such as a cockpit domain controller (CDC), since the lighting information may reach a display system late relative to drawing data which reaches the display system, lighting control of a backlight based on the lighting information is delayed relative to the control of the display, with the result that it is disadvantageously difficult to perform backlight lighting control which follows the displayed image.

Hence, as described above, image display device 10 in technique 1 in the present embodiment is image display device 10 that performs local dimming control, image display device 10 includes: image display 12 that displays an image; light 14 that lights up as a backlight for image display 12; communicator 11 that communicates with an external device (drawing processing device 20) to acquire the image and lighting information for controlling light 14 based on the image; and lighting processor 13 that controls light 14 based on a time difference between a lighting timing indicated by the lighting information and a display timing of the image, the image is one of a plurality of images that are displayed by image display 12, and lighting processor 13 generates complementary lighting information: that is based on an (N−1)th image and an Nth image among the plurality of images; and that complements a period between a display timing of the (N−1)th image and a display timing of the Nth image.

In this way, the complementary lighting information which can complement the period between the display timing of the (N−1)th image and the display timing of the Nth image is generated, and thus it is possible to smoothly change the brightness of lighting corresponding to the (N−1)th image to the brightness of lighting corresponding to the Nth image.

Hence, in image display device 10, lighting control which follows the displayed image can be performed. Consequently, the user who views an image displayed on image display device 10 is unlikely to feel uncomfortable in its brightness.

Image display device 10 in technique 2 in the present embodiment is image display device 10 described in technique 1. In this case, lighting processor 13: calculates difference data on a difference between the (N−1)th image and the Nth image; and generates complementary lighting information by adding a part of the difference data calculated to lighting information corresponding to the (N−1)th image in accordance with a lighting interval between lighting corresponding to the lighting information corresponding to the (N−1)th image and lighting corresponding to lighting information corresponding to the Nth image.

In this way, it is possible to generate the complementary lighting information in accordance with the lighting interval between lighting corresponding to the lighting information corresponding to the (N−1)th image and lighting corresponding to the lighting information corresponding to the Nth image, and thus it is possible to smoothly change the brightness corresponding to the lighting information corresponding to the (N−1)th image to the brightness corresponding to the lighting information corresponding to the Nth image. Consequently, the user who views the image displayed on image display device 10 is unlikely to feel uncomfortable in its brightness.

Image display device 10 in technique 3 in the present embodiment is image display device 10 described in technique 1. In this case, lighting processor 13: calculates difference data on a difference between the (N−1)th image and the Nth image; calculates an amount of change in brightness of a specific region included in a lighting area indicated by the difference data calculated and an amount of change in brightness of a related region associated with the specific region; and generates complementary lighting information by estimating a direction of change in brightness based on the amount of change in brightness of the specific region and the amount of change in brightness of the related region.

In this way, it is possible to generate, based on the lighting information corresponding to the (N−1)th image and the lighting information corresponding to the Nth image, the complementary lighting information in accordance with a lighting interval between lighting corresponding to the lighting information corresponding to the Nth image and lighting corresponding to the lighting information corresponding to the (N+1)th image. Hence, it is possible to smoothly change the brightness corresponding to the lighting information corresponding to the Nth image to the brightness corresponding to the lighting information corresponding to the (N+1)th image. Consequently, the user who views the image displayed on image display device 10 is unlikely to feel uncomfortable in its brightness.

Image display device 10 in technique 4 in the present embodiment is image display device 10 described in technique 1. In this case, lighting processor 13 applies the complementary lighting information when brightness increases from lighting information corresponding to the (N−1)th image to lighting information corresponding to the Nth image.

In this way, since the user easily feels uncomfortable when brightness increases, it is possible to smoothly change brightness using the complementary lighting information which complements a period between the lighting information corresponding to the (N−1)th image and the lighting information corresponding to the Nth image.

Image display device 10 in technique 5 in the present embodiment includes: image display device 10 that performs local dimming control; and an external device (drawing processing device 20), image display device 10 includes: image display 12 that displays an image; light 14 that lights up as a backlight for image display 12; communicator 11 that communicates with the external device (drawing processing device 20) to acquire the image and lighting information for controlling light 14 based on the image; and lighting processor 13 that controls light 14 based on a time difference between a lighting timing indicated by the lighting information and a display timing of the image, the external device (drawing processing device 20) is a CDC, and generates the image and the lighting information for controlling light 14 based on the image, the image is one of a plurality of images that are displayed by image display 12, and the external device (drawing processing device 20): compares an (N−1)th image and an Nth image among the plurality of images; generates complementary lighting information that complements a period between a display timing of the (N−1)th image and a display timing of the Nth image; and transmits the complementary lighting information to image display device 10.

In image display system 1 described above, the same operational effects as in image display device 10 described above are achieved.

An image display method in technique 6 in the present embodiment is an image display method for performing local dimming control, the image display method includes: displaying an image by image display 12; causing light 14 to light up as a backlight for image display 12; communicating with an external device (drawing processing device 20) by communicator 11 to acquire the image and lighting information for controlling light 14 based on the image; and controlling light 14 by lighting processor 13 based on a time difference between a lighting timing indicated by the lighting information and a display timing of the image, the image is one of a plurality of images that are displayed by image display 12, and lighting processor 13 generates complementary lighting information: that is based on an (N−1)th image and an Nth image among the plurality of images; and that complements a period between a display timing of the (N−1)th image and a display timing of the Nth image.

In image display system 1 described above, the same operational effects as in image display device 10 described above are achieved.

A program in technique 7 in the present embodiment is a program for causing a computer to execute the image display method.

In the program described above, the same operational effects as in the image display method described above are achieved.

(Other variations)

Although the image display device, the image display system, the image display method, and the program according to the present disclosure have been described above based on the above embodiment, the present disclosure is not limited to the embodiment described above. Embodiments obtained by performing various variations conceived by those skilled in the art on the embodiment may be included in the scope of the present disclosure without departing from the spirit of the present disclosure.

For example, in the image display device, the image display system, the image display method, and the program according to the embodiment described above, drawing processing device 20 may generate the complementary lighting information. In other words, the function of generating the complementary lighting information which is included in the lighting processor may be incorporated in the drawing processing device.

Embodiments obtained by performing various variations conceived by those skilled in the art on the above embodiment and embodiments realized by any combination of constituent elements and functions in the above embodiment without departing from the spirit of the present disclosure are also included in the present disclosure.

While the embodiment has been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims is incorporated herein by reference in its entirety: Japanese Patent Application No. 2025-026807 filed on Feb. 21, 2025.

### INDUSTRIAL APPLICABILITY

The present disclosure is useful in a display device, a display system, a processing device, an image display device such as an electronic device, and an image display system.

1. An image display device that performs local dimming control, the image display device comprising:
an image display that displays an image;
a light that lights up as a backlight for the image display;
a communicator that communicates with an external device to acquire the image and lighting information for controlling the light based on the image; and
a lighting processor that controls the light based on a time difference between a lighting timing indicated by the lighting information and a display timing of the image,
wherein the image is one of a plurality of images that are displayed by the image display, and
the lighting processor generates complementary lighting information:
that is based on an (N−1)th image and an Nth image among the plurality of images; and
that complements a period between a display timing of the (N−1)th image and a display timing of the Nth image.

2. The image display device according to claim 1,
wherein the lighting processor:
calculates difference data on a difference between the (N−1)th image and the Nth image; and
generates complementary lighting information by adding a part of the difference data calculated to the lighting information corresponding to the (N−1)th image in accordance with a lighting interval between lighting corresponding to the lighting information corresponding to the (N−1)th image and lighting corresponding to the lighting information corresponding to the Nth image.

3. The image display device according to claim 1,
wherein the lighting processor:
calculates difference data on a difference between the (N−1)th image and the Nth image;
calculates an amount of change in brightness of a specific region included in a lighting area indicated by the difference data calculated and an amount of change in brightness of a related region associated with the specific region; and
generates complementary lighting information by estimating a direction of change in brightness based on the amount of change in brightness of the specific region and the amount of change in brightness of the related region.

4. The image display device according to claim 1,
wherein the lighting processor applies the complementary lighting information when brightness increases from the lighting information corresponding to the (N−1)th image to the lighting information corresponding to the Nth image.

5. An image display system comprising:
an image display device that performs local dimming control; and
an external device,
wherein the image display device includes:
an image display that displays an image;
a light that lights up as a backlight for the image display;
a communicator that communicates with the external device to acquire the image and lighting information for controlling the light based on the image; and
a lighting processor that controls the light based on a time difference between a lighting timing indicated by the lighting information and a display timing of the image,
the external device is a cockpit domain controller (CDC), and generates the image and the lighting information for controlling the light based on the image,
the image is one of a plurality of images that are displayed by the image display, and
the external device:
compares an (N−1)th image and an Nth image among the plurality of images;
generates complementary lighting information that complements a period between a display timing of the (N−1)th image and a display timing of the Nth image; and
transmits the complementary lighting information to the image display device.

6. An image display method for performing local dimming control, the image display method comprising:
displaying an image by an image display;
causing a light to light up as a backlight for the image display;
communicating with an external device by a communicator to acquire the image and lighting information for controlling the light based on the image; and
controlling the light by a lighting processor based on a time difference between a lighting timing indicated by the lighting information and a display timing of the image,
wherein the image is one of a plurality of images that are displayed by the image display, and
the lighting processor generates complementary lighting information:
that is based on an (N−1)th image and an Nth image among the plurality of images; and
that complements a period between a display timing of the (N−1)th image and a display timing of the Nth image.

7. A non-transitory computer-readable storage medium having recorded thereon a program for causing a computer to execute the image display method according to claim 6.
